(19) United States
(12) Patent Application Publication
(10) Pub. No.: US 2005/0071557 A1
(43) Pub. Date: Mar. 31, 2005

(54) Method and apparatus for recording log information in disk array system

(75) Inventors: Kazunari Kawamura, Ome-shi (JP); Takehiko Kurashige, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/943,234

(22) Filed: Sep. 17, 2004

(30) Foreign Application Priority Data
Sep. 30, 2003 (JP) 2003-339980

(51) Int. Cl. G06F 12/00

(52) U.S. Cl. 711/114

(57) ABSTRACT

In a disk array system including a plurality of disk drives, a RAID controller prepares log information in response to event occurrence of each of the disk drives. The RAID controller records the log information in a log recording area included in a reserve area as a specified area with which the OS of a host system is not concerned.

### CROSS-REFERENCE TO RELATED APPLICATIONS

This application is based upon and claims the benefit of priority from prior Japanese Patent Application No. 2003-339980, filed Sep. 30, 2003, the entire contents of which are incorporated herein by reference.

### BACKGROUND OF THE INVENTION

1. Field of the Invention

The present invention generally relates to a disk array system, and a recording technique for logging information about a disk drive.

2. Description of the Related Art

In general, as a disk array (or RAID: redundant arrays of inexpensive disks) system, a RAID system (RAID-0) including a striping constitution in which data is scattered by a block unit and having level 0, a RAID system (RAID-1) including a mirroring constitution in which the same data is stored in a plurality of disk drives and having level 1 and the like are well known.

Additionally, a disk array controller (RAID controller) prepares and stores log information concerning event generation, for example, when events such as errors occur in each disk drive (HDD). The log information is useful information usable by a host system at the time of an analysis process with respect to the occurrence of trouble in the RAID system.

As a method of recording the log information, there is a method in which the information is stored in a nonvolatile memory disposed inside the RAID controller. However, since the nonvolatile memory usually has a relatively small capacity, recordable log information is limited, and therefore, for example, there is a possibility that sufficient log information necessary for analyzing the trouble cannot be obtained.

To solve the problem, an information recording device has been proposed in which in a user area of a disk drive having a large capacity, error information concerning errors occurring in the area is recorded, and the error information is transferred to the host system (see, for example, Jpn. Pat. Appln. KOKAI Publication No. 6-131128).

In a prior-art method, an operating system (OS) of the host system is concerned, and the log information is recorded in the user area of the disk drive. In this method, when trouble occurs in the disk drive, the OS stored in the disk drive cannot function, and there is a possibility that it is difficult to record and acquire the log information.

### BRIEF SUMMARY OF THE INVENTION

In accordance with one embodiment of the present invention, there is provided a RAID control apparatus including a facility which records a relatively large amount of log information without depending on an OS of a host system.

The RAID control apparatus comprises: an input/output control unit which controls input/output of data with respect to each disk drive included in a disk array system in accordance with an access request from a host system; and a recording control unit which sets a specified area in a reserve area except a user data recording area concerned with the host system and which records log information in the specified area in accordance with event occurrence in each disk drive in the disk drive.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a constitution of a RAID system according to an embodiment of the present invention;

FIG. 2 is a diagram showing a constitution of a recording area of a disk drive according to the present embodiment;

FIG. 3 is a block diagram showing a constitution or a RAID controller according to the present embodiment;

FIGS. 4A to 4C are explanatory views of a redundancy method of log information according to the present embodiment;

FIG. 5 is a diagram showing a concrete example of a log recording area according to the present embodiment;

FIG. 6 is a diagram showing a concrete example of a reserve area according to the present embodiment; and

FIG. 7 is a flowchart showing a procedure of the redundancy method of the log information according to the present embodiment.

### DETAILED DESCRIPTION OF THE INVENTION

An embodiment of the present invention will be described hereinafter with reference to the drawings.

(System Constitution)

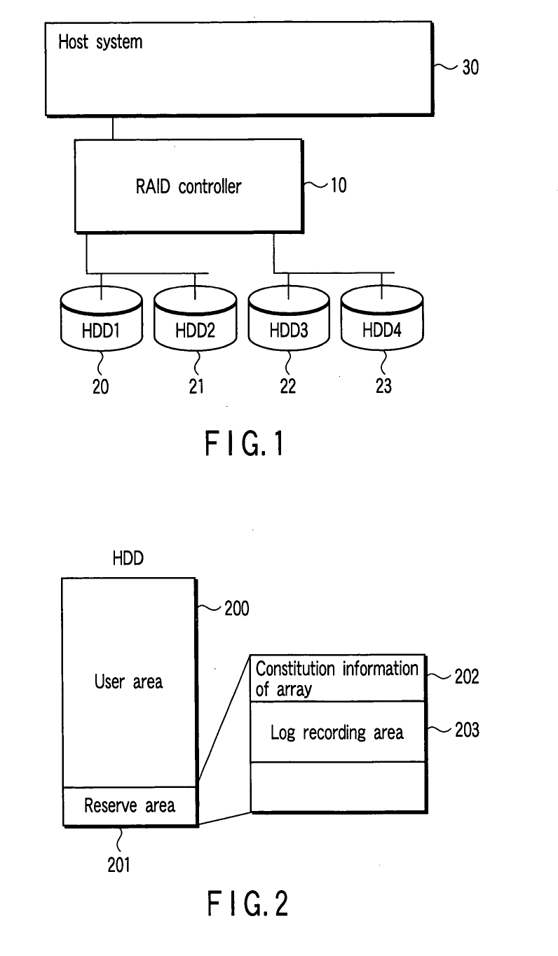

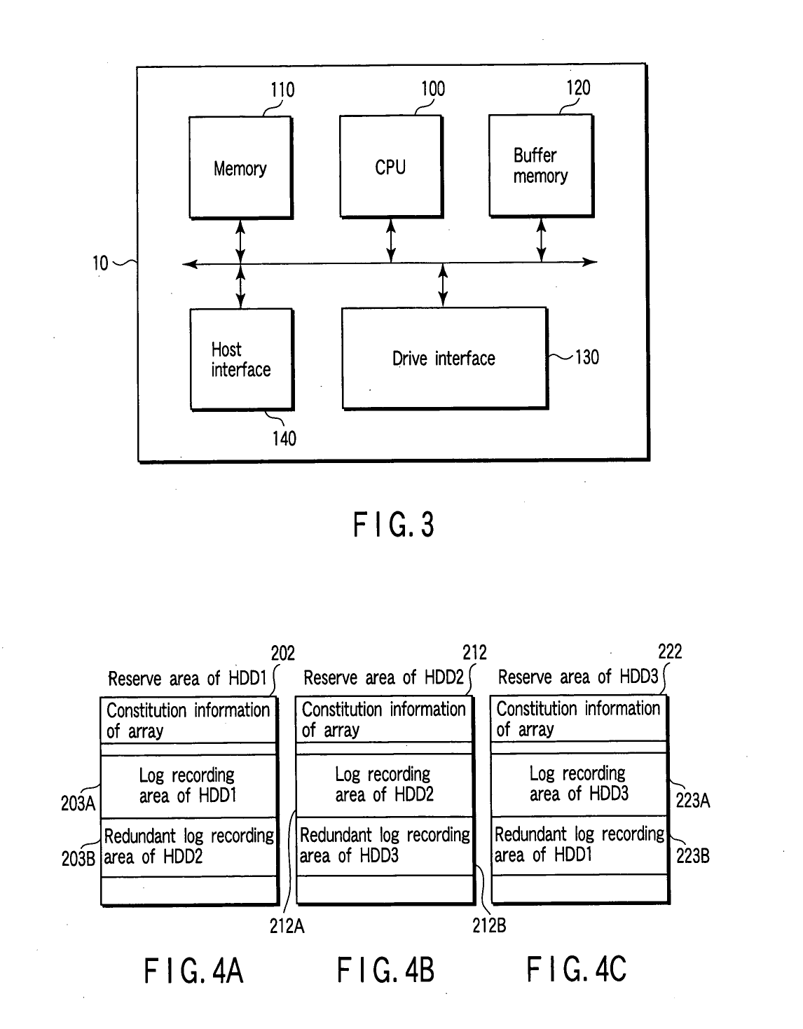

FIGS. 1 and 2 are block diagrams showing a constitution of a RAID system (disk array system) according to the present embodiment. FIG. 3 is a block diagram showing a constitution of a RAID controller (disk array controller).

As shown in FIG. 1, a RAID controller 10 of the present embodiment is connected to first to fourth disk drives 20 to 23 to realize a RAID system (referred to as RAID-10 for convenience) in which RAID-0 and RAID-1 are combined. The RAID controller 10 issues a command necessary for controlling input/output (read and write operations) of data with respect to the respective disk drives 20 to 23 in response to an access request (command) from a host system (including an operating system: OS), for example, a personal computer or a server.

As shown in FIG. 3, the RAID controller 10 has a microprocessor (CPU) 100, a memory 110, a buffer memory 120, a drive interface 130, and a host interface 140.

The CPU 100 is a main control device which executes a RAID control operation including a recording function of log information of the present embodiment. The memory 110 includes a ROM in which a program of the CPU 100 is stored, a flash EEPROM, and RAM. The buffer memory 120 includes a buffer RAM and a cache memory.

The drive interface 130 corresponds to a microcontroller which is connected to a plurality of disk drives 20 to 23 and which controls the input/output of the data. In the present embodiment, for example, four disk drives can be connected. The host interface 140 is an interface which controls the transfer of data and commands with respect to a host system (personal computer, server, etc.) in which RAID is used as an external storage device.

It is to be noted that the RAID controller 10 of the present embodiment may be constituted of a hardware logic circuit which exclusively realizes RAID-10 instead of other constituting elements excluding the drive interface 130 and host interface 140.

Concretely, in the present embodiment, the RAID controller 10 may be a card type controller attached to a card slot disposed, for example, in the personal computer and connected to a plurality of disk drives to realize the RAID-10.

(Recording Method of Log Information)

A method of recording log information of the present embodiment will be described hereinafter with reference to FIG. 2.

As shown in FIG. 2, each of the disk drives 20 to 23 of the RAID system is divided into a user area (user data recording area) 200 for recording user data, and a reserve area 201 for recording information of the RAID system. The user area 200 is a recording area with which the host system (OS) 30 is concerned and in which the OS itself is stored in addition to the user data.

On the other hand, the reserve area 201 is a specified area with which the host system (OS) 30 cannot be concerned and which is managed (controlled) by the RAID controller 10. Concretely, the information of the RAID system is constitution information of the array (sometimes hereinafter referred to simply as array information).

In the present embodiment, the RAID controller 10 divides the reserve area 201 into an area 202 for recording constitution information of the area and a log recording area 203 for recording the log information. In other words, a part of the reserve area 201 is secured as the log recording area 203.

As described above, when events such as errors occur in the respective disk drives 20 to 23, the RAID controller 10 of the present embodiment prepares log information concerning the events, and records the information in the log recording area 203 secured in each reserve area 201.

The RAID controller 10 can take the log information from the log recording area 203 and supply the information to the host system 30, when the host system 30 executes an analysis process with respect to trouble occurrence of the RAID.

In a method of recording the log information in the present embodiment, the log information is stored in the log recording area 203 included in the reserve area 201 with which the host system (OS) 30 cannot be concerned. Therefore, even when the OS cannot function, the information is stored without any problem. That is, without depending on the OS, the RAID controller 10 is capable of preparing the log information in response to the occurrence of the event, recording the information in the log recording area 203, and taking out the log information in response to a request from the OS.

It is to be noted that a storage area of the user area 200 is relatively reduced in order to secure the log recording area 203 in the reserve area 201. However, for example, in a disk drive having a capacity of 40 Gbytes, even when the log recording area 203 is 2 Mbytes in the reserve area 201, the area is about only 0.005% with respect to a total capacity, and no problem is caused by the increased capacity. On the other hand, when the log recording area 203 has a capacity of 2 Mbytes, 4096 pieces of log information by a unit of 512 bytes can be recorded, and a sufficient capacity can be obtained in this manner.

(Redundancy Method of Log Information)

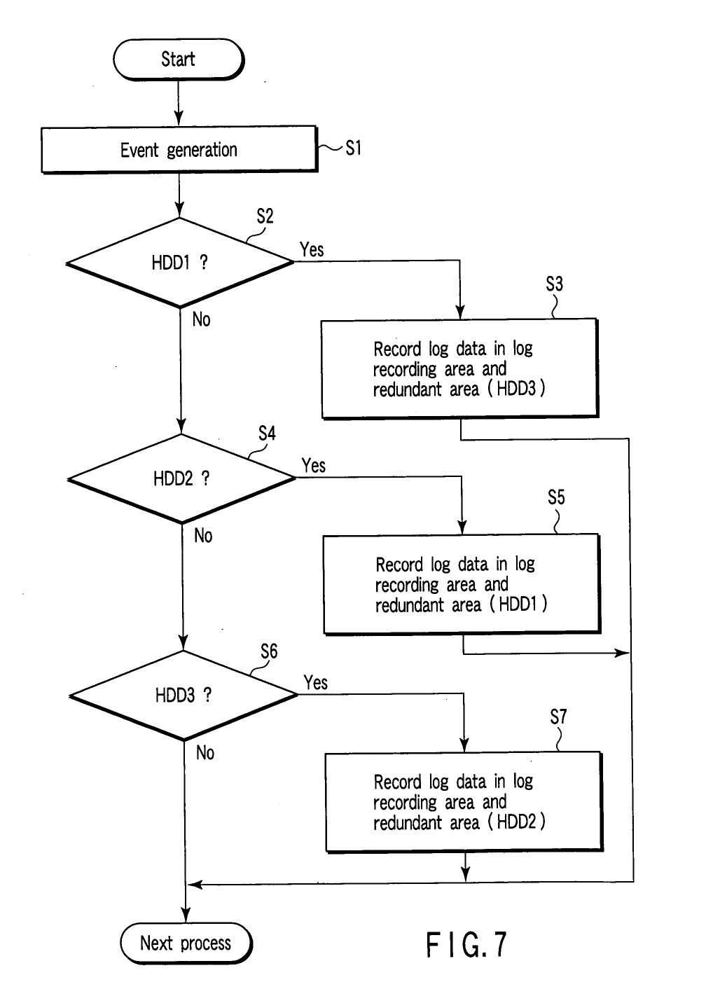

Next, a redundancy method of the log recording area will be described with reference to FIGS. 4A to 4C and a flowchart of FIG. 7.

In general, the log information is required most in a case where trouble occurs in the disk drive. However, it is assumed that the controller 10 is not capable of recording the log information in the log recording area 203 or acquiring the log information from the log recording area 203 in the disk drive in which the problem occurs.

To solve the problem, the RAID controller 10 of the present embodiment realizes a redundant log recording area, for example, in a group of three disk drives 20 to 22 belonging to the RAID.

As shown in FIG. 4A to 4C, in reserve areas of the respective disk drives (disk drives 1 to 3) 20 to 22, in addition to the areas 202, 212, 222 for recording the constitution information of the array, log recording areas 203A, 212A, 223A for recording own log information and redundant log recording areas 203B, 212B, 223B are secured.

As shown in FIG. 4A, the RAID controller 10 records the log information (log data) in the log recording area 203A, when an error occurs in the disk drive 20 (HDD1) at the time of the occurrence of the event.

Furthermore, as shown in FIG. 4C, the RAID controller 10 records the log information of the disk drive 1 in the redundant log recording area 223B of the disk drive (disk drive 3) 22 (step S3).

Alternatively, as shown in FIG. 4C, the RAID controller 10 records the log information (log data) in the log recording area 223A, when the error occurs in the disk drive (disk drive 3) 22 (YES in step S6).

Furthermore, as shown in FIG. 4B, the RAID controller 10 records the log information of the disk drive 3 in the redundant log recording area 212B of the disk drive (disk drive 2) 21 (step S7).

As described above, the RAID controller 10 records the log information of the respective disk drives 20 to 22 not only in the respective log recording areas but also in the redundant log recording areas of the other disk drives.

Therefore, for example, when trouble occurs in the disk drive (disk drive 1) 20, and the log information of the disk drive 1 cannot be taken out, the RAID controller 10 can acquire the log information of the disk drive 1 from the redundant log recording area 223B of the disk drive 3.

(Concrete Example of Log Recording Area)

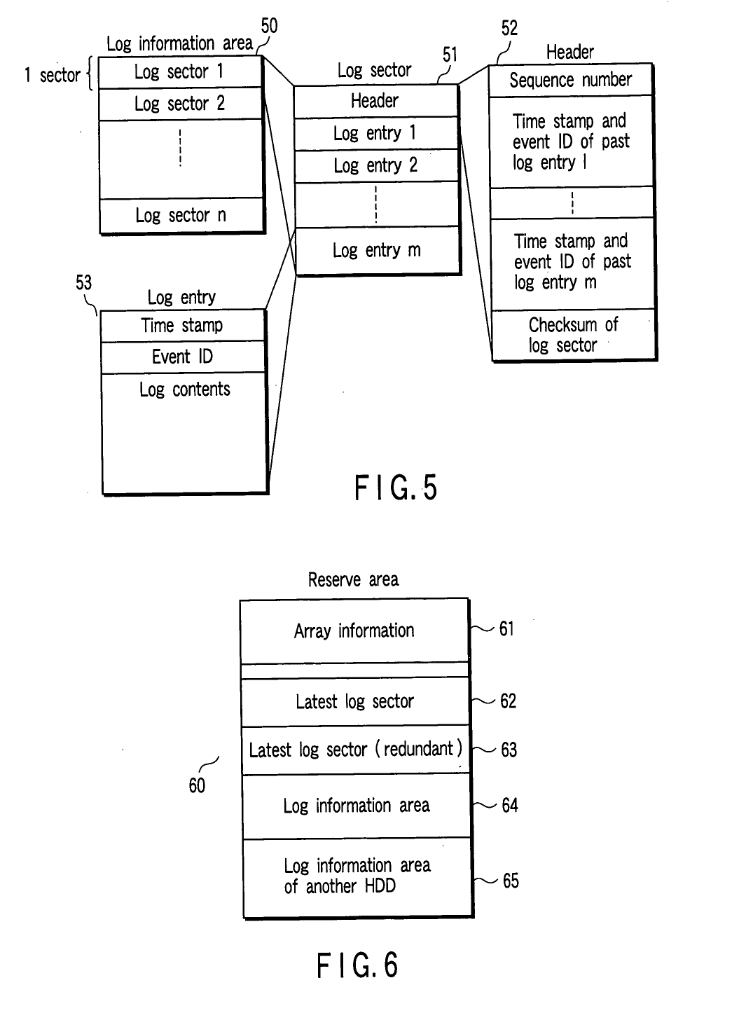

In general, in the disk drive, an access unit of the data is a sector (block) unit of 512 bytes. Therefore, the log recording area 203 of the present embodiment is also divided into n sectors (referred to as log sectors for convenience) and managed. A concrete format of the log recording area will be described hereinafter with reference to FIG. 5.

Here, an area for recording usual log information (log data) in the log recording area is referred to as a log information area 50 for convenience (described later with reference to FIG. 6).

As described above, the log information area 50 is constituted of n log sectors 1 to n. Each log sector 51 is divided into a header 52 and m log entry areas 1 to m. In the header 52, a sequence number of the log sector 51, a checksum, and a time stamp and event identification information (ID) of the past log are recorded. Moreover, data of contents of the time stamp, event ID, and log are recorded in each log entry area 53.

The RAID controller 10 overwrites an oldest log sector to delete the information, when there is no empty area in the log information area 50. At this time, the RAID controller 10 stores the time stamps and event IDs only of the log entry areas 1 to m to be deleted in the header 52. Accordingly, the log information is reduced, but the amount of recordable log information can be doubled.

(Concrete Example of Reserve Area)

FIG. 6 shows a reserve area 60 constituted of a concrete format with respect to the reserve area 201 of the present embodiment.

In the reserve area 60, a log sector 62 for recording latest log information only, and a redundant sector 63 are secured as other areas except a log information area 64 for recording the above-described usual log information.

In this reserve area 60, the rewriting frequency of the latest log information is usually relatively large. Since the RAID controller 10 accesses only the log sector 62, the efficiency of the rewriting process of the log information can be raised. Since the redundant sector 63 is secured, reliability with respect to storage of the latest log information can be enhanced. It is to be noted that a log information area 65 for another disk drive, shown in FIG. 6, is corresponds to the redundant log recording area shown in FIG. 4.

According to the present embodiment, the specified area with which the host system (OS) is not concerned is secured to record the log information in the recording area of each disk drive, and therefore the log information can be stored without depending on the host system (OS).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A RAID control apparatus comprising:
an input/output control unit which controls input/output of data with respect to each of disk drives included in a disk array system in response to an access request from a host system; and
a recording control unit which sets a specified area in a reserve area not concerning the host system except a user data recording area concerning the host system in the disk drive and which records log information in the specified area in accordance with occurrence of an event in the disk drive.

2. The RAID control apparatus according to claim 1, wherein the recording control unit records the log information corresponding to the disk drive in the specified area and in the specified area of another disk drive.

3. The RAID control apparatus according to claim 1, wherein the recording control unit divides the specified area into a plurality of sectors as recording areas of the log information,
sets the respective sectors to a header area and a plurality of log entry areas,
records contents of the log information for each event with respect to each of the log entry areas, and
records specified information related to past log information except present log information recorded in the log entry area with respect to the header area.

4. The RAID control apparatus according to claim 1, wherein the recording control unit divides the specified area into a plurality of sectors as recording areas of the log information,
sets the respective sectors to a header area and a plurality of log entry areas,
records contents of the log information for each event with respect to each of the log entry areas, and
records specified information including a time stamp and an event ID related to past log information deleted from the log entry area in the header area.

5. The RAID control apparatus according to claim 1, wherein the recording control unit sets a recording area except a log information area to record usual log information as the specified area, and records latest log information in the recording area.

6. The RAID control apparatus according to claim 1, wherein the recording control unit sets a recording area except a log information area to record usual log information as the specified area, and records latest log information and redundant information in the recording area.

7. The RAID control apparatus according to claim 1, wherein the recording control unit records constitution information of the disk array system in a first area of the reserve area with which the host system is not concerned, and
sets a second area of the reserve area as the specified area to record log information for each disk drive.

8. The RAID control apparatus according to claim 1, wherein the recording control unit records constitution information of the disk array system in a first area of the reserve area with which the host system is not concerned,
sets a second area of the reserve area as the specified area to record log information for each disk drive, and
sets a third area of the reserve area as a redundant log recording area to record log information of another disk drive.

9. A method of recording log information of disk drives in a disk array system, the method comprising:
controlling input/output of data with respect to the respective disk drives in response to an access request from a host system;
preparing the log information in accordance with events occurring in the respective disk drives; and
recording the log information in a specified area with which the host system is not concerned in specified areas of the respective disk drives.

10. The method according to claim 9, further comprising:
recording the log information corresponding to the respective disk drives in the respective specified areas; and
recording the log information in a specified area with which the host system is not concerned in a specified area of another disk drive.
